(19) United States
(12) Patent Application Publication
(10) Pub. No.: US 2014/0092707 A1
(43) Pub. Date: Apr. 3, 2014

(54) Operational Mode Switching in Seismic Data Acquisition Module via Supply Voltage Polarization

(71) Applicant: GLOBAL GEOPHYSICAL SERVICES, INC., Missouri City, TX (US)

(72) Inventors: Ralph Buckley Muse, JR., Dallas, TX (US); Graham Michael Scott, Irving, TX (US); Caroline M. Branch, Dallas, TX (US)

(73) Assignee: Global Geophysical Services, Inc., Missouri City, TX (US)

(21) Appl. No.: 13/830,438

(22) Filed: Mar. 14, 2013

Related U.S. Application Data
(60) Provisional application No. 61/707,805, filed on Sep. 28, 2012.

(51) Int. Cl. G01V 1/24

(52) U.S. Cl. CPC G01V 1/247
USPC 367/14

(57) ABSTRACT

Described herein are various embodiments of methods and corresponding hardware and software that are configured to permit a seismic data acquisition module to switch between a data acquisition operational mode and a USB data downloading mode according to the sensed polarity of an external power supply that is connected to the module.

### RELATED APPLICATION

This application claims priority and other benefits from U.S. Provisional Patent Application Ser. No. 61/707,805 entitled “Seismic Data Acquisition Module with High Dynamic Range and Signal-to-Noise Ratio ADC and Broadband Antenna, and Corresponding Systems, Devices, Components and Methods” to Muse et al. filed Sep. 28, 2012 (hereafter “the '805 patent application”), which is hereby incorporated by reference in its entirety.

### FIELD

Various embodiments described herein relate to the field of seismic data acquisition and processing, and systems , devices, components and methods associated therewith.

### BACKGROUND

Seismic data acquisition modules generally need to run in two different operating modes: (a) acquiring seismic data, and (b) downloading the seismic data they have acquired and stored.

While acquiring seismic data, the module must do so with a minimum use of power so that the external battery connected thereto can be of a size that is easily portable into remote field areas with a minimum amount of effort. To do so, generally all non-data-acquisition-related downloading circuitry should be turned off, as it is not required during the acquisition or uploading of data.

Moreover, the inclusion of a reliable solid state switch in such a module that is immune from environmental conditions, such as jostling, dropping, impacts, static electricity, humidity, heat, cold and other environmental conditions likely to occur under field use, is problematic because once the module has been deployed in a unmonitored position in the field, the operational mode of the module cannot be guaranteed or known at any given time. Also problematic are mechanical and magnetic lock and key type switches having moving parts that need to be serviced and sealed, or that require complimentary devices to switch operational modes of the module.

What is needed are systems, devices, components and methods capable of distinctly and unambiguously changing and defining the operational mode of a seismic data acquisition module without employing additional equipment, indicators, contacts, or conductors, other than those required to operate in the required operational modes.

### SUMMARY

In one embodiment, there is provided a seismic data acquisition module, comprising a processor, an input connector comprising at least first and second pins or receptacles, and a power supply circuit configured to receive an external power supply voltage provided by an external battery or an external data downloading device through the input connector, wherein the connector is operably connected to the power supply circuit and configured for connection to the external power supply voltage, the power supply circuit is operably connected to the connector and configured to detect a first polarity of a first voltage presented across the first and second pins or receptacles when the external battery is connected thereto, and to detect a second polarity of a second voltage presented across the first and second pins or receptacles when the external data downloading device is connected thereto, the first polarity being opposite the second polarity, the power supply circuit further being operably connected to the processor and being configured to send a first signal to the processor when the first polarity is detected and to send a second signal to the processor when the second polarity is detected, the processor being configured to switch its operational mode to a first data acquisition operational mode when the first polarity is detected and the first signal is received thereby, and to switch its operational mode to a second data download operational mode when the second polarity is detected and the second signal is received thereby.

In another embodiment, there is provided a method of switching operational modes in a seismic data acquisition module comprising a processor, an input connector comprising at least first and second pins or receptacles, and a power supply circuit configured to receive an external power supply voltage provided by an external battery or an external data downloading device through the input connector, the connector being operably connected to the power supply circuit and configured for connection to the external power supply voltage, the power supply circuit being operably connected to the connector and configured to detect a first polarity of a first voltage presented across the first and second pins or receptacles when the external battery is connected thereto, and to detect a second polarity of a second voltage presented across the first and second pins or receptacles when the external data downloading device is connected thereto, the first polarity being opposite the second polarity, the method comprising operating the module in a first data acquisition operational mode when the first polarity is detected, and operating the module in a second data download operational mode when the second polarity is detected.

Further embodiments are disclosed herein or will become apparent to those skilled in the art after having read and understood the specification and drawings hereof.

### BRIEF DESCRIPTION OF THE DRAWINGS

Different aspects of the various embodiments will become apparent from the following specification, drawings and claims in which:

FIG. 1 shows one embodiment of a seismic data acquisition module 10;

FIG. 2 one embodiment of a connector 16 that may be employed in conjunction with seismic data acquisition module 10;

FIG. 3 shows one embodiment of circuitry 20 that may be employed in seismic data acquisition module 10;

FIG. 4 shows another embodiment of circuitry 20 that may be employed in seismic data acquisition module 10;

FIG. 5 shows one embodiment of power supply circuit 44/46 of seismic data acquisition module 10 operating in a USB data downloading mode;

FIG. 6 shows one embodiment of power supply circuit 44/46 of seismic data acquisition module 10 operating in a data acquisition mode;

FIG. 7 shows one embodiment of a method 200 of switching the operational modes of a seismic data acquisition module 10.

The drawings are not necessarily to scale. Like numbers refer to like parts or steps throughout the drawings, unless otherwise noted.

### DETAILED DESCRIPTIONS OF SOME EMBODIMENTS

In the following description, specific details are provided to impart a thorough understanding of the various embodiments of the invention. Upon having read and understood the specification, claims and drawings hereof, however, those skilled in the art will understand that some embodiments of the invention may be practiced without hewing to some of the specific details set forth herein. Moreover, to avoid obscuring the invention, some well known methods, processes, devices, components and systems finding application in the various embodiments described herein are not disclosed in detail.

In the drawings, some, but not all, possible embodiments are illustrated, and further may not be shown to scale.

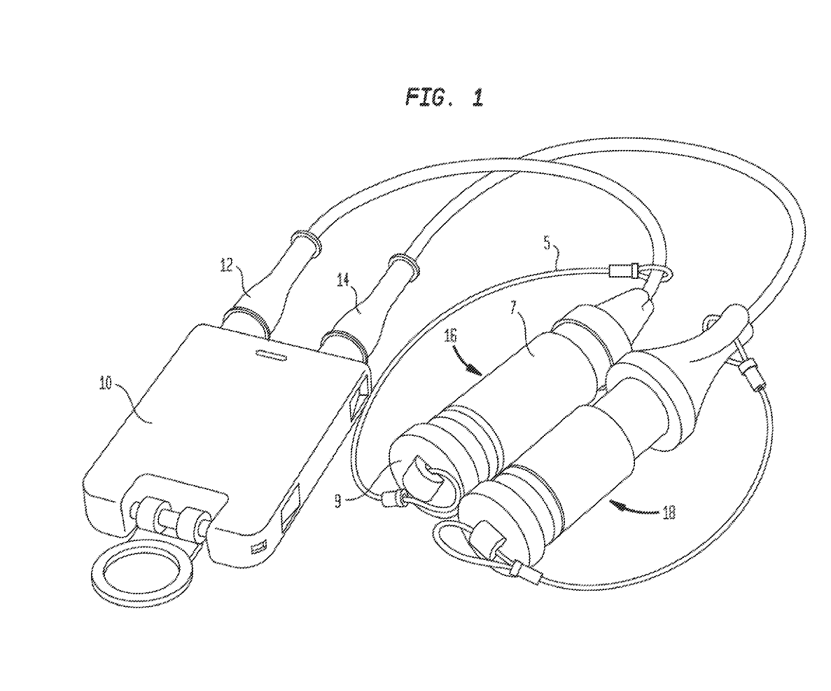

FIG. 1 shows an AUTOSEIS™ HDR (high data resolution) seismic data acquisition module 10 with accompanying geophone cable 14 and connector 18, and external battery power/data downloading cable 12 and connector 16. Caps 9 protect connectors 16 and 18 when they are not in use and disconnected from an external power source, such as a rechargeable lithium ion battery especially designed for the purpose, or a data harvesting device and its associated connector, which is configured for downloading stored seismic data from module 10.

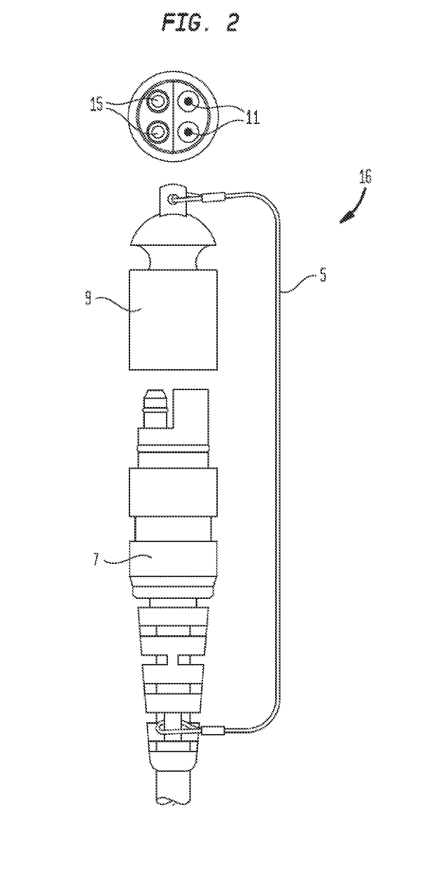

FIG. 2 shows one embodiment of connector 16 comprising connector body 7, connector cap 9, and pins 15 and 11.

According to one embodiment, basic operation of the AutoSeis HDR seismic data acquisition module 10 is as follows. A geophone is connected to standard geophone connector 18. A geophone is a very sensitive instrument (similar to a microphone) with an analog output of 5 volts peak to peak. This input is feed into module 10 and thence into a PreAmp and then into an analog-to-digital converter (ADC). While module 10 may be configured, by way of example, to record seismic data at 0.5, 1, 2, or 4 milliseconds sample rates, the ADC runs at a much higher rate (called over-sampling). The ADC then outputs a digital signal at a considerably faster rate than the 0.5, 1, 2, or 4 milliseconds sample rate. An FPGA Processor then performs a vertical stack (or average) of a large number of these samples and outputs this “stacked” value to a main processor, where the data are saved to flash storage (or a memory). As a result of this “stacking,” the desired seismic signals are increased and undesired noise is decreased, resulting in a high dynamic range.

According to one embodiment, the ADC has a very accurate reference voltage applied thereto that is important to satisfactory operation. Module 10 uses two references voltages and a monitoring circuit which constantly monitors the two voltages and sends a signal to the processor if any detrimental difference in voltages occurs, at which point module 10 may be put into an alarm state and shut down.

The complete system of module 10 is controlled by a very accurate clock, which is also controlled by a GPS subsystem. The GPS turns on periodically (where such timing is set by a user) and resets the clock to the correct time. The GPS then turns off to save power. This timing system (the Clock and the GPS) controls the timing rates for the ADC and the recorded time in the seismic data.

When module 10 is first deployed in the field it performs a number of system tests, and then uses a signal created by an internal DAC to measure both the resistance and the impedance of the geophone(s) operably connected thereto. This value is recorded and an alarm generated if the value is out of specification.

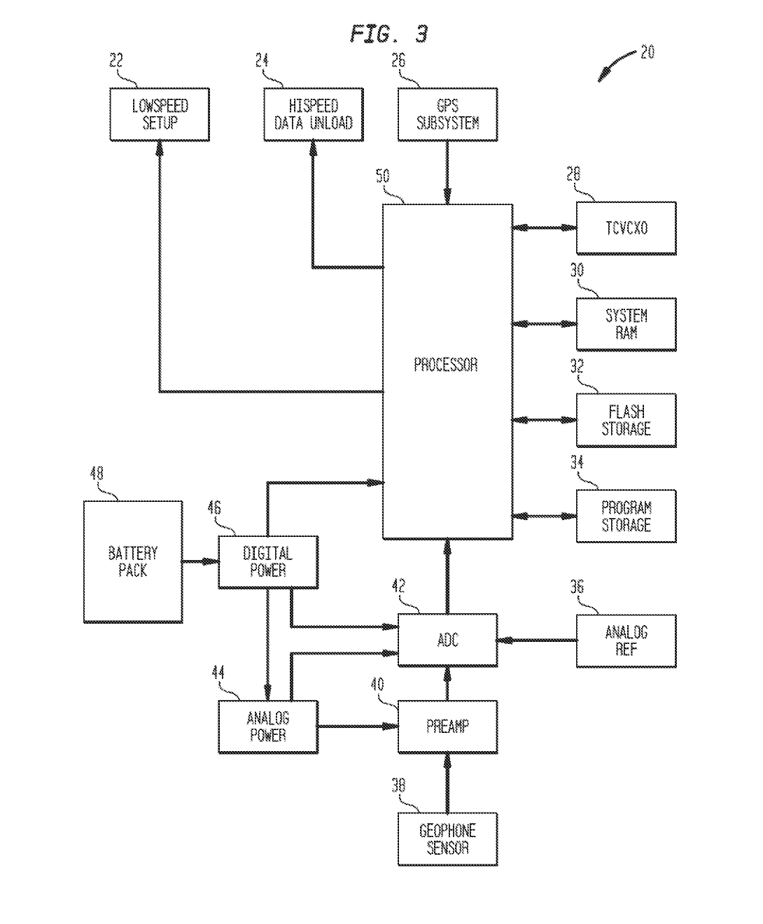

FIG. 3 shows one embodiment of a block diagram of circuitry 20 contained within module 10, which as shown includes LOWSPEED SETUP 22, HISPEED DATA UNLOAD 24, GPS SUBSYSTEM 26, PROCESSOR 50, ADC 42, PREAMP 40, GEOPHONE SENSOR 38 ANALOG POWER 44, DIGITAL POWER 46, BATTERY PACK 48 ANALOG REF 36, PROGRAM STORAGE 34, FLASH STORAGE 32, SYSTEM RAM 30 AND TCVCXO 28. Numerous combinations, permutations, adjustments and changes can be made to the embodiment of circuitry 20 shown in FIG. 3, as those skilled in the art will understand after having read and understood the present specification and accompanying drawings.

Further details regarding this and other embodiments of module 10 may be found in the following documents, copies of which are included in the '805 patent application, and which are also hereby incorporated by reference herein each in its respective entirety: (a) “AutoSeis Specification, Details & Scope,” which describes various details relating to one embodiment of an AUTOSEIS™ seismic data acquisition module 10; (b) “AutoSeis Autonomous Nodal Technologies Quick Start Field Manual,” which also describes various details relating to one embodiment of an AUTOSEIS™ seismic data acquisition module 10; (c) “AutoSeis Autonomous Nodal Technologies,” which further describes various details relating to one embodiment of an AUTOSEIS™ seismic data acquisition module 10; (d) one embodiment of a workflow for an AUTOSEIS seismic data acquisition module 10 (as set forth in Appendix D of the '805 patent application).

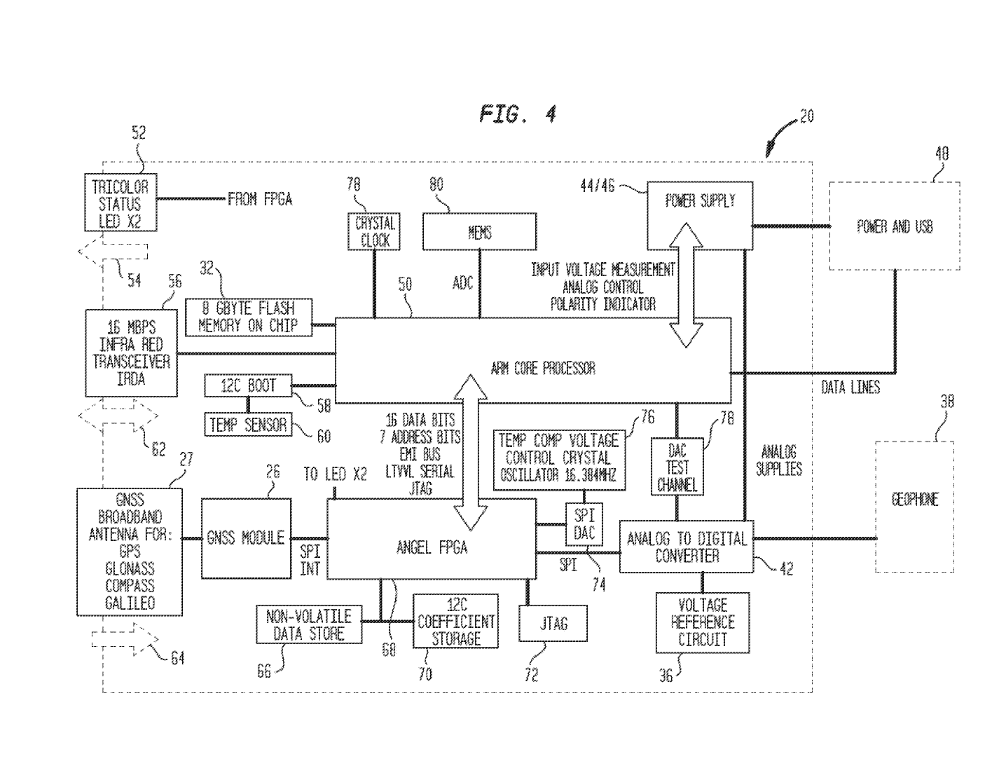

FIG. 4 shows yet another block diagram according to another embodiment of circuitry 20 of seismic data acquisition module 10. In FIG. 4, the acronyms employed therein have the following meanings: DAC=DIGITAL TO ANALOG CONVERTER; EMI=EXTERNAL MEMORY INTERFACE; FPGA=FIELD PROGRAMMABLE GATE ARRAY; GNSS=GLOBAL NAVIGATION SATELLITE SYSTEM; I2C=INTER-INTEGRATED CIRCUIT; INT=INTERRUPT; IRDA=INFRA RED DATA ASSOCIATION; JTAG=JOINT TEST ACTION GROUP INTERFACE; LVTTL=LOW VOLTAGE TRANSISTOR TRANSISTOR LOGIC; MEMS=MICRO ELECTRICAL MECHANICAL SYSTEM; PPS=PULSE PER SECOND; SPI=SERIAL PERIPHERAL INTERFACE; USB=UNIVERSAL SERIAL BUS.

The various portions of circuitry 20 shown in FIG. 4 operate, are interconnected, and are configured to carry out the various functionalities ascribed thereto as follows: ARM CORE PROCESSOR 50 is the main processor of module 10 and controls processes and data storage. MEMS 80 is on-board MEMS sensor used to make the unit aware of orientation and motion, where a signature external “double tap” of the unit is decoded to send current status to the LEDs flush volatile memory to flash and turn on IRDA if dormant. Crystal clock 78 is a 37 kHz clock, and the main processor clock. POWER AND USB 48 is configured to provide external power and communications/data transfer through a 4-pin connector and using a standard USB protocol, with an extended voltages ranging between 5 and 24 volts. GEOPHONE 38 is a geophone that provides analog data through seismic industry standard 2 pin KCK connector. ANALOG TO DIGITAL CONVERTER 42 is an analog signal conditioning and conversion module configured to convert analog signals provided by GEOPHONE 38, and is further capable of digital data filtering and storage. ANGEL FPGA 68 receives digital data, filters the digital data, and prepares the digital data for flash memory storage. GNSS MODULE 26 GNSS module decodes positioning information, including accurate timing data, and provides date and time information that can be used to calibrate the FPGA's clock. GNSS BROADBAND ANTENNA FOR: GPS, GLONASS, COMPASS and GALILEO 27 is a broadband helical antenna capable of receiving frequencies from all or most of the world's major satellite systems. TRICOLOR STATUS LED X252 comprises two sets of 2 tricolor LED clusters capable of displaying unit mode and status to a filed operative observing the unit. POWER SUPPLY 44/46 provides the various voltage supplies, both digital and analog, to run all the onboard sub-systems. In particular, it is configured to sense the polarity of the incoming voltage providing control of the desired operating mode of the unit. Positive voltage compliant with standard USB protocol is decoded as “Download Mode” enabling the USB data lines to be engaged, where module 10 prepares itself for the download of data and the upload of firmware and operating parameters. In the case that the incoming voltage is opposite to the standard USB protocol, module 10 enters a data acquisition mode and records seismic data. TEMP COMP VOLTAGE CONTROL CRYSTAL OSCILLATOR 16.384 MHZ 76 is a high-quality crystal oscillator used to run FPGA 68 at the accuracy required to record satisfactory data, where the oscillator is calibrated and adjusted by the PPS from GNSS MODULE 26. 16 MBPS INFRA RED TRANSCEIVER IRDA 56 is an IRDA transceiver enabled to permit external communication with module 10 other than through the USB interface, which is of particular relevance to obtaining unit or module status and sub-systems status in “Acquisition Mode” as an alternative to the USB interface. SPI DAC 74 is a digital-to-analog converter enabling control of the 16.384 MHz oscillator. 8 GBYTE FLASH MEMORY ON CHIP 32 is commercial grade flash memory in an integrated circuit format providing main storage for acquired data. I2C BOOT 58 is an I2C serial interface boot loader. TEMP SENSOR 60 is an onboard temperature sensor providing real time data for clock compensation and data to be stored for operational use. NON VOLATILE DATA STORE 66 provides additional FPGA data storage. DAC TEST CHANNEL 78 generates digitally produced signals and wave forms that can be converted to analog signals and injected into analog-to-digital converter 42 to test and check the analog section's performance. 16 DATA BITS, 7 ADDRESS BITS, EMI BUS, LVTTL SERIAL, and JTAG are digital control and data lines between FPGA 68 and processor 50. PPS, SPI and INT are digital control and data lines disposed between FPGA 68 and GNSS module 26. INPUT VOLTAGE MEASUREMENT, ANALOG CONTROL and POLARITY INDICATOR are analog and digital control and data lines disposed between power supply 44/46 and processor 50. ANALOG SUPPLIES are high-quality clean analog power supply lines configured to provide power to the analog section. DATA LINES are a standard protocol USB data pair enabled when in USB/download mode. FROM FPGA TO LED X2 (not shown completely in FIG. 4) are data lines configured to provide unit status to LEDs. JTAG 72 is a JTAG header and bus available for board level testing before encapsulation of module 10. SPI is a serial peripheral interface between ADC 42 and FPGA 68. ADC refers to analog lines disposed between MEMS 80 and processor 50's onboard ADC. VOLTAGE REFERENCE CIRCUIT 36 is an independent voltage control circuit to provide additional control of the voltage level supplied to the analog section.

Numerous combinations, permutations, adjustments and changes can be made to the embodiment of circuitry 20 shown in FIG. 4, as those skilled in the art will understand after having read and understood the present specification and accompanying drawings.

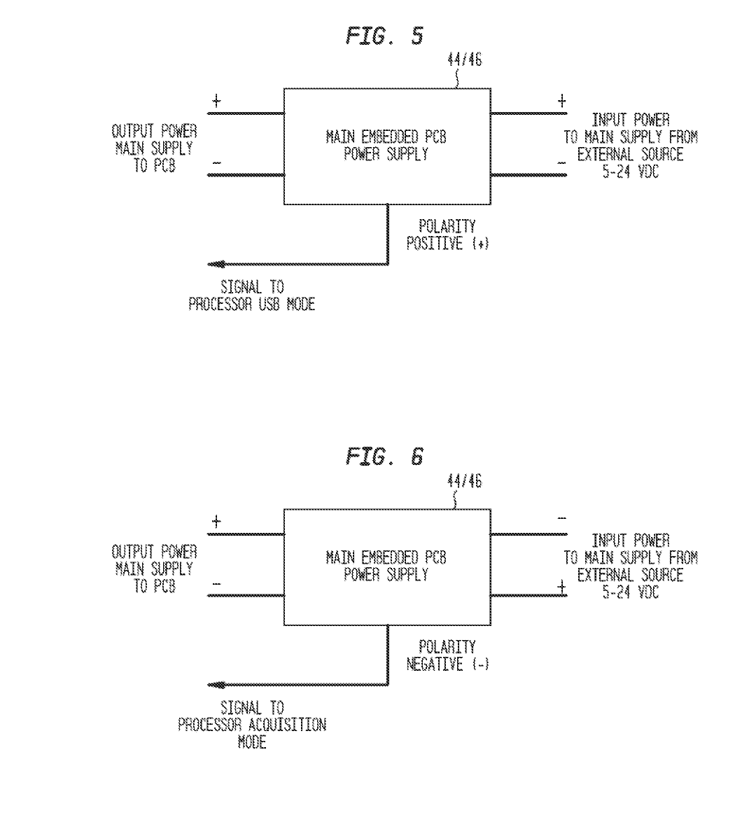

Turning now to FIGS. 5 and 6, there is shown power supply circuit 44/46 operating in USB data downloading mode (FIG. 5), or in data acquisition mode (FIG. 6). In the USB data downloading mode represented by FIG. 5, the polarity of the external power source (e.g., an external power source connected to a data harvesting device or rack at a central field or other location) is sensed as having a first polarity associated therewith. In the data acquisition mode represented by FIG. 6, the polarity of the external power source (e.g., an external field lithium ion battery) is sensed as having a second polarity associated therewith, where the first polarity is opposite the second polarity. According to polarity of the input external power supply sensed by circuit 44/46, the operational mode of module remains, or is switched to (as the case may be) a USB data downloading operational mode or a data acquisition operational mode.

Continuing to refer to FIGS. 5 and 6, and also to FIGS. 1 through 4, input connector 16 comprises at least first and second pins or receptacles 11 and 15, and power supply circuit 44/46 is configured to receive an external power supply voltage provided by an external battery 48 or an external data downloading device through input connector 16. Connector 16 is operably connected to power supply circuit 44/46 and is configured for connection to the external power supply voltage. Power supply circuit 44/46 is operably connected to connector 16 and configured to detect a first polarity of a first voltage presented across the first and second pins or receptacles 11 and 15 when external battery 48 is connected thereto, and to detect a second polarity of a second voltage presented across the first and second pins or receptacles 11 and 15 when the external data downloading device is connected thereto. The first polarity is opposite the second polarity. Power supply circuit 44/46 is further operably connected to processor 50 and configured to send a first signal (“SIGNAL TO PROCESSOR USB MODE” in FIG. 5) to processor 50 when the first polarity is detected, and to send a second signal (“SIGNAL TO PROCESSOR ACQUISITION MODE” in FIG. 6) to processor 50 when the second polarity is detected. Processor 50 is configured to switch its operational mode to a first data acquisition operational mode when the first polarity is detected and the first signal is received thereby, and to switch its operational mode to a second data download operational mode when the second polarity is detected and the second signal is received thereby.

The first polarity detected may be negative or positive, as may the second polarity. The first signal may be any one of a positive voltage signal, a negative voltage signal, and an unchanged voltage signal. The second signal may also be one of a positive voltage signal, a negative voltage signal, and an unchanged voltage signal.

According to one embodiment, power supply circuit 44/46 may form a portion of a printed circuit board, may be configured to provide power to operate data acquisition module 10, may be configured to receive input power across the first and second pins or receptacles 11 and/or 15 that ranges between about 5 volts DC and about 24 volts DC, and/or may be a switched mode power supply.

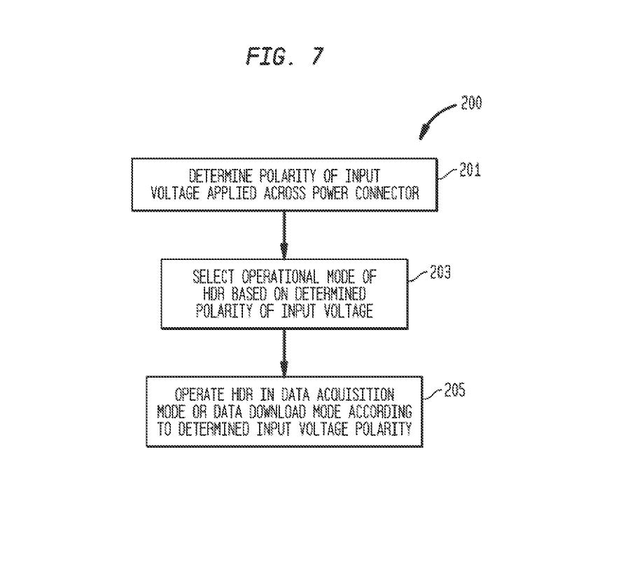

The power supply circuit shown in FIGS. 5 and 6 may also be employed in a method 200 of switching operational modes in seismic data acquisition module 10, as illustrated by steps 201, 203 and 205 in FIG. 7. In one such method, module 10 and power supply circuit 44/46 together act to operate module 10 in a first data acquisition operational mode when the first polarity is detected, and to operate module 10 in a second data download operational mode when the second polarity is detected.

Various portions of circuitry 20 may be disabled during the data downloading or data acquisition operational modes, as those skilled in the art will understand after having read and understood the present specification and drawings. Details concerning USB protocols that may be employed to carry out the methods described herein may be found in “Universal Serial Bus Specification” Revision 2.0 dated Apr. 27, 2000 published by Compaq, Hewlett Packard, Intel, Lucent, Microsoft, NEC and Philips.

The above-described embodiments should be considered as examples, rather than as limiting the scope of the various embodiments. In addition to the foregoing embodiments, review of the detailed description and accompanying drawings will show that there are other embodiments not explicitly disclosed herein. Accordingly, many combinations, permutations, variations and modifications of the foregoing embodiments not set forth explicitly herein will nevertheless fall within the scope of what is claimed herein.

We claim:

1. A seismic data acquisition module, comprising:
a processor;
an input connector comprising at least first and second pins or receptacles, and
a power supply circuit configured to receive an external power supply voltage provided by an external battery or an external data downloading device through the input connector;
wherein the connector is operably connected to the power supply circuit and configured for connection to the external power supply voltage, the power supply circuit is operably connected to the connector and configured to detect a first polarity of a first voltage presented across the first and second pins or receptacles when the external battery is connected thereto, and to detect a second polarity of a second voltage presented across the first and second pins or receptacles when the external data downloading device is connected thereto, the first polarity being opposite the second polarity, the power supply circuit further being operably connected to the processor and being configured to send a first signal to the processor when the first polarity is detected and to send a second signal to the processor when the second polarity is detected, the processor being configured to switch its operational mode to a first data acquisition operational mode when the first polarity is detected and the first signal is received thereby, and to switch its operational mode to a second data download operational mode when the second polarity is detected and the second signal is received thereby.

2. The seismic data acquisition module of claim 1, wherein the first polarity is detected to be negative.

3. The seismic data acquisition module of claim 2, wherein the first signal is one of a positive voltage signal, a negative voltage signal, and an unchanged voltage signal.

4. The seismic data acquisition module of claim 1, wherein the second polarity is detected to be positive.

5. The seismic data acquisition module of claim 4, wherein the second signal is one of a positive voltage signal, a negative voltage signal, and an unchanged voltage signal.

6. The seismic data acquisition module of claim 1, wherein the second operational mode is a USB data downloading mode.

7. The seismic data acquisition module of claim 1, wherein the power supply circuit forms a portion of a printed circuit board.

8. The seismic data acquisition module of claim 1, wherein the power supply circuit is configured to provide power to operate the data acquisition module.

9. The seismic data acquisition module of claim 1, wherein the power supply circuit is configured to receive input power across the first and second pins or receptacles ranging between about 5 volts DC and about 24 volts DC.

10. The seismic data acquisition module of claim 1, wherein the power supply circuit is a switched mode power supply.

11. A method of switching operational modes in a seismic data acquisition module comprising a processor, an input connector comprising at least first and second pins or receptacles, and a power supply circuit configured to receive an external power supply voltage provided by an external battery or an external data downloading device through the input connector, the connector being operably connected to the power supply circuit and configured for connection to the external power supply voltage, the power supply circuit being operably connected to the connector and configured to detect a first polarity of a first voltage presented across the first and second pins or receptacles when the external battery is connected thereto, and to detect a second polarity of a second voltage presented across the first and second pins or receptacles when the external data downloading device is connected thereto, the first polarity being opposite the second polarity, the method comprising:
operating the module in a first data acquisition operational mode when the first polarity is detected, and
operating the module in a second data download operational mode when the second polarity is detected.

12. The method of claim 11, further comprising sending a first signal to the processor from the power supply circuit, the first signal being indicative of the first polarity having been detected.

13. The method of claim 11, further comprising sending a second signal to the processor from the power supply circuit, the second signal being indicative of the second polarity having been detected.

14. The method of claim 11, wherein the second operational mode is a USB data downloading mode.

15. The method of claim 11, further comprising the module receiving and storing in a memory thereof signals from at least one geophone operably connected thereto while the module is operating in the first data acquisition operational mode.
